(19) United States
(12) Patent Application Publication
(10) Pub. No.: US 2010/0183293 A1
(43) Pub. Date: Jul. 22, 2010

(54) APPARATUS AND METHODS FOR INDICATING THE OPERATIONAL CONDITION OF A COMMUNICATION DEVICE

(76) Inventors: Xiangzhong Wang, Milpitas, CA (US); Zining Huang, Cupertino, CA (US); Jianyao Chen, Milpitas, CA (US)

Correspondence Address: Kaplan Gilman & Pergament LLP, 1480 Route 9 North, Woodbridge, NJ, 07095, US

(21) Appl. No.: 12/356,927

(22) Filed: Jan. 21, 2009

(51) Int. Cl. H04B 10/08; G08B 5/00; H04B 10/00

(52) U.S. Cl. 398/9; 340/815.4; 340/815.42; 398/135

(57) ABSTRACT

A communication interface module is disclosed, wherein the module may include a circuit board having an electronic communication interface and an optical communication interface; a light source disposed on the circuit board, wherein the light source is indicative of a status of at least one operational condition of the module; a module cover coupled to the circuit board; and a light path extending from the light source on the circuit board to a portion of the module cover visible to a human operator.

### BACKGROUND OF THE INVENTION

The present invention relates in general to indicating the status of the operation of a communication system and in particular to the indication of the operational status of an optical communication system.

The ability to indicate the status of one or more activities within a communication and/or processing system is helpful in managing and controlling the communication system. In traditional data processing systems, signals indicative of the operation of a system, including fault conditions, could be transmitted, using electronic digital data transmission, to a data processing system capable of appropriately storing such data, curing any reported problem, and/or notifying another entity of a reported fault condition. Likewise, optical communication systems may be operated so as to transmit operational status information, such as a fault condition, to a data processing system using electronic digital data transmission.

However, in some instances it may be convenient to provide a notification of the operational status of a communication system, including fault conditions, that is visible to a human operator in the location where the fault or other condition occurs. Accordingly, there is a need in the art for improved methods and apparatus for indicating the operational status of communication devices including optical communication devices.

### SUMMARY OF THE INVENTION

According to one aspect, the invention is directed to a communication interface module that may include a circuit board having an electronic communication interface and an optical communication interface; a light source disposed on the circuit board, wherein the light source is indicative of a status of at least one operational condition of the module; a module cover coupled to the circuit board; and a light path extending from the light source on the circuit board to a portion of the module cover visible to a human operator.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a perspective view of a communication interface module in accordance with an embodiment of the present invention;

FIG. 2 is a partially sectional and partially perspective view of a portion of the module of FIG. 1 showing a light source and a light path suitable for illustrating an operational condition of a system, in accordance with an embodiment of the invention;

FIG. 3 is a perspective view of a portion of the module of FIG. 1 illustrating a circuit board and a condition-indicator light path of the module, in accordance with an embodiment of the present invention;

FIG. 4 is a perspective view of the cover of the module of FIG. 1 in accordance with an embodiment of the present invention;

FIG. 5 is another perspective view of the cover of the module of FIG. 1 in accordance with an embodiment of the present invention;

FIG. 6 is schematic representation of a status indicator light path from an LED light source to a termination point of the light path;

FIGS. 7A and 7B are schematic plan views of the fluctuation of exemplary light paths as a function of variation in the relative location of a light pipe with respect to a light source, along an X axis, in accordance with an embodiment of the present invention;

FIGS. 8A and 8B are schematic elevational views of the fluctuation of exemplary light paths as a function of variation in the relative location of a light pipe with respect to a light source along a Y axis, in accordance with an embodiment of the present invention; and

FIGS. 9A and 9B are schematic elevational views of the fluctuation of exemplary light paths with variation in the relative location of a light pipe with respect to a light source, along a Z axis, in accordance with an embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

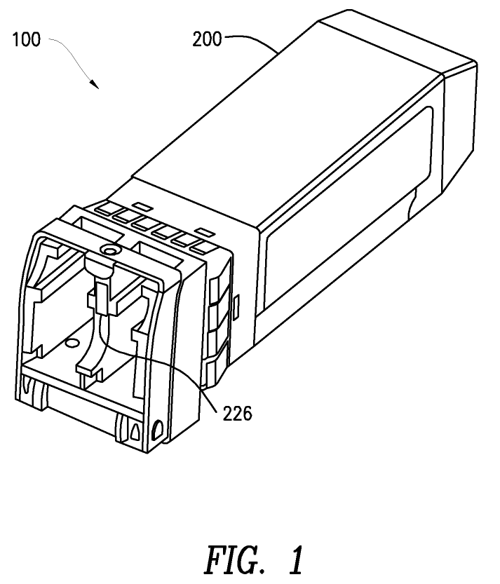

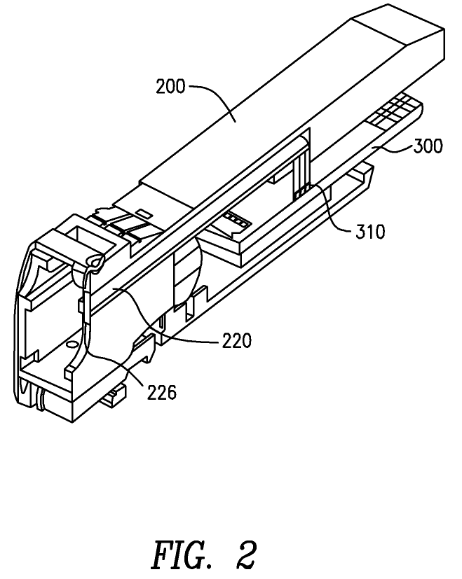

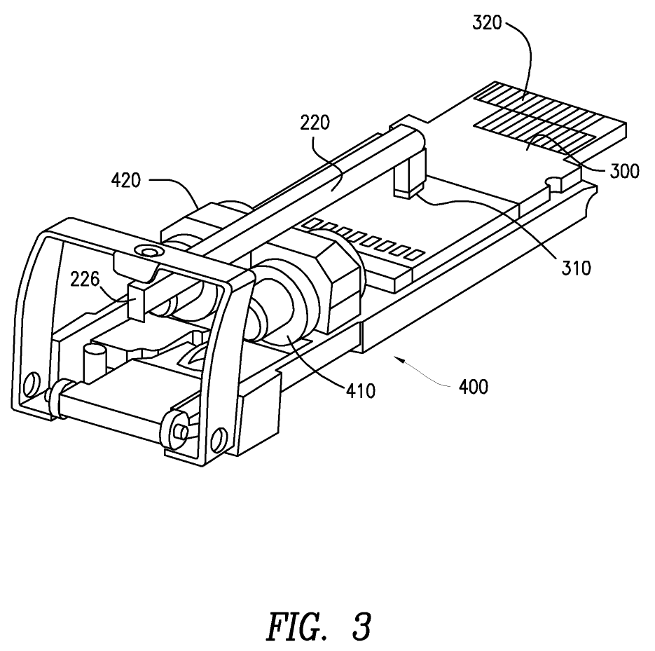

FIG. 1 is a perspective view of a communication interface module 100. FIG. 2 is a perspective view of a portion of the module 100 showing a light source 310 and a light path 220 suitable for illustrating an operational status of the module 100. And, FIG. 3 is a perspective view of a portion of the module of FIG. 1 illustrating a circuit board and a light path of the module, in accordance with an embodiment of the present invention. Reference is made to FIGS. 1-3 in the following.

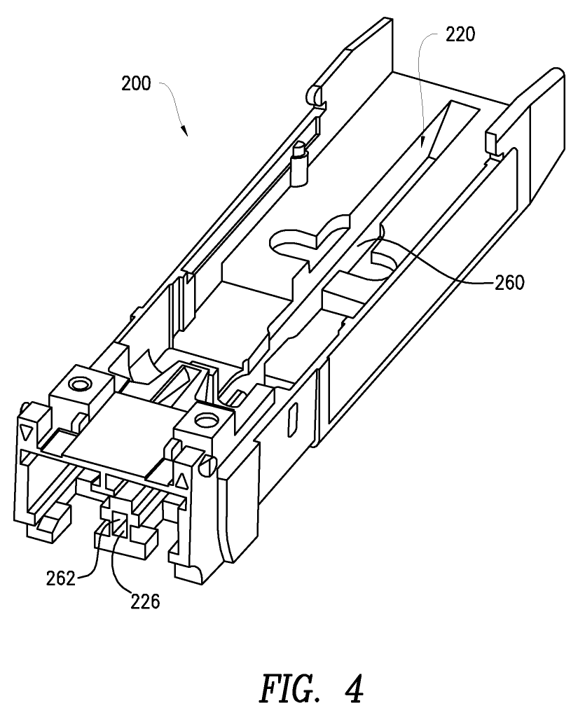

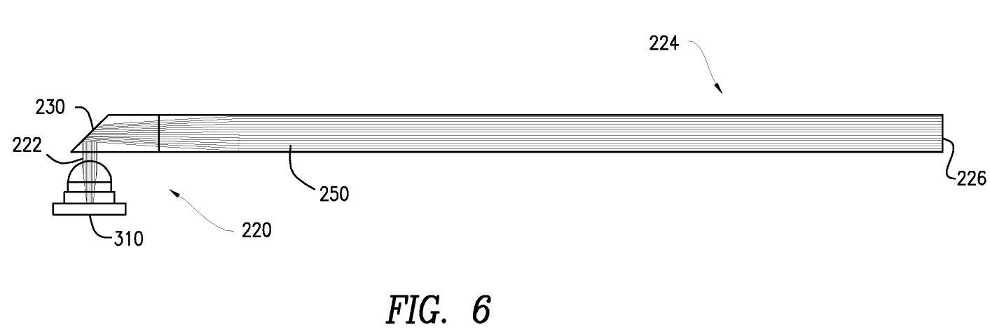

Module 100 may include cover 200 and/or circuit board 300. Circuit board 300 may include light source 310 and/or computer data interface 320. Module 100 may include additional panels and structural members needed to form a secure mechanical assembly. However, for the sake of brevity the structure of such additional parts are not discussed in detail herein. Cover 200 may include groove 260 leading to through hole 262 (FIG. 4). Light path 220 may include first light path segment 222, second light path segment 224, and/or termination point 226. Second light path segment 224 may be a light pipe 250 (FIGS. 6-9) which may include a reflector 230. In an alternative embodiment, reflector 230 may form part of cover 200.

In one embodiment, module 100 is operable to inform a human operator of the operational condition of module 100. For example, in the event of a fault condition, light source 310 may be activated to indicate the fault condition or other condition. Light path 220 (which may include two or more segments 222, 224 that may intersect and form a substantially right-angled junction as shown in FIG. 3) may conduct light from light source 310 along the length of light path 220 to light path termination point 226. Preferably, light path termination point 226 provides illumination that is readily viewable and noticeable by a human operator. In this manner, module 100 is operable to notify an operator of a fault condition, or other operating condition. Moreover, directing the light in the manner disclosed herein may provide a visual indication of a fault or other operating condition in a more convenient and/or more accessible location than the location of light source 310 itself.

Computer data interface 320 is preferably a conventional digital computer data communication interface. Light source 310 may be a conventional surface mounted (SMT) Light Emitting Diode (LED) that may be mounted on circuit board 300. In one embodiment, the LED used may receive a supply current that is 20 milliamperes (mA) or less, and which uses 70 milliwatts (mW) or less. However, in other embodiments, current in excess of 20 mA and/or power in excess of 70 mW may be supplied to light source 310.

Herein, the light path 220 preferably corresponds to the entirety of the light path in between light source 310 and the point (preferably termination point 226) that is illuminated for viewing by an operator. Various different structural entities may form one or more portions of light path 220, which may include a first segment 222, a second segment 224, optional additional segments if desired (not shown), and a termination point 226. In one embodiment, light source 310 directs light along a first segment 222 that is substantially perpendicular to the plane of the surface of circuit board 300. Light transmission along first segment 222 may occur through free space. However, in alternative embodiments, a light guide could be implemented to conduct light along first segment 222.

In this embodiment, light traveling along first segment 222 could be reflected at reflector 230 and through light pipe 250 (FIGS. 6-9) which may be employed for second segment 224 of light path 220. Light pipe 250 may extend from reflector 230 to termination point 226 of light path 220. Thus, in this embodiment, light travels through free space in first segment 222, and through solid material in second segment 224. In this embodiment, reflector 230 of light pipe 250 may be configured to accommodate a 90 degree angular separation between first segment 222 and second segment 224 of light path 220. However, other angular separations between the two light path 200 segments 222, 224 may be employed. Moreover, in other embodiments, three or more light path 220 segments may be employed if desired.

In other embodiments, any combination of free space light transmission and solid light guide light transmission may be employed. Thus, first segment 222 could employ either free space light transmission or solid-light-guide light transmission or a combination of the two approaches. Correspondingly, the second segment 224 could also employ either free-space light transmission or solid-light-guide light transmission, or a combination of the two approaches.

The light pipe 220 and/or the lens on light source 310 may be composed of polycarbonate and/or polymethylmethacrylate (PMMA) materials. In other embodiments, light guides other than the above-discussed light pipes may be employed. In some embodiments, light path 220 may be implemented in free space, using suitable materials along the interior of an evacuated passage within cover 200 that leads toward termination point 226. Various specific implementations of light path 220 are described below.

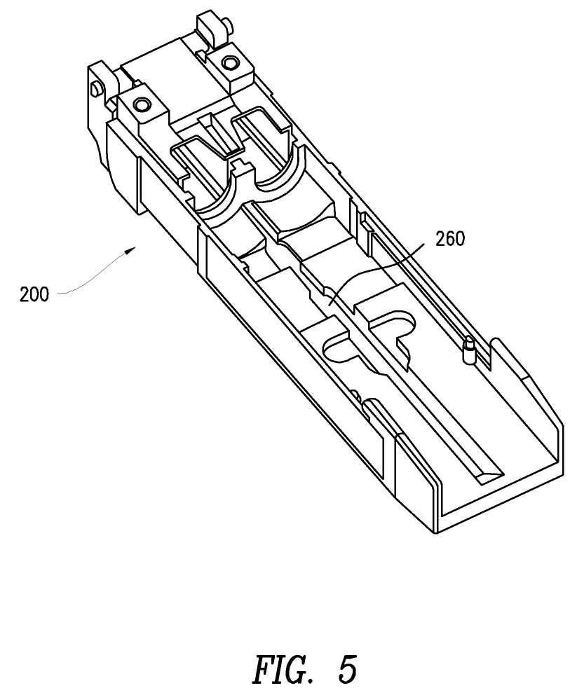

Module 100 may also include conventional optical equipment 400 which may include photo-detector 410 and/or laser 420 (FIG. 3). For the sake of brevity, these optical components are not discussed further herein. Having described the overall function of module 100, attention is now directed the structure of cover 200 in greater detail in connection with FIGS. 4-5 below.

FIG. 4 is a perspective view of the cover 200 of module 100 of FIG. 1 in accordance with an embodiment of the present invention. FIG. 5 is another perspective view of cover 200. FIGS. 4-5 provide perspective views of cover 200 that are upside down in relation to the orientation of cover 200 as shown in FIGS. 1-3.

A portion of light path 220 is shown that includes groove 260 that extends through hole 262, shown at the lower left of FIG. 4. Groove 260 may be operable to house a light pipe 250 (FIGS. 6-9) for conveying light along the second segment 224 of light path 220 to termination point 226 of light path 220. There may be a single continuous opening from groove 260 to through hole 262. However, the cross-sectional geometry of this opening is not necessarily constant, and may vary as needed along the length of groove 260. Thus, the cross-sectional dimensions of the groove 260 and the through hole 262 need not be the same.

In one embodiment, through hole 262 may be about 1.65 millimeters (mm) high and about 1.05 mm wide. Through hole 262 may receive a rectangular bar (not shown) that may have a height of 1.60 mm±0.02 mm and a width of 1.00 mm±0.02 mm. The above-described rectangular may serve as a light guide forming one segment of light path 220. In the embodiment shown in FIGS. 4-5, it may be seen that a portion of light path 220 may be formed through a combination of grooves within cover 200.

FIG. 6 is schematic side view of a status indicator light path 220 from an LED light source 310 to a termination point 226 of the light path 220. In this embodiment, light source 310, which may be an LED, directs light upward from a circuit board 300 (not shown in FIG. 6) along first segment 222 of light path 220. The light eventually reaches reflector 230 and is directed along second segment 224 of light path 220, in the rightward direction in the view of FIG. 6. The light travels along second segment 224 and ultimately reaches termination point 226. In some embodiments, one or more devices may be placed at termination point 226 to provide optimal visibility of the end of light path 220 by a human operator and/or by a machine capable of detecting the illumination present at termination point 226. In this embodiment, second segment 224 may be a light pipe 250 that includes reflector 230.

Reflector 230 is preferably a part of light pipe 250. In an alternative embodiment, reflector 230 may be a separate part and be secured in proximity to light pipe 250. Either way, in this embodiment, the plane of the reflection surface of reflector 230 is preferably oriented at forty-five degrees with respect to the light transmission direction along the first segment 222 of light path 220. In this embodiment, the second segment 224 is preferably oriented at ninety degrees with respect to the first segment 222 of light path 220. However, in other embodiments, other orientations of reflector 230 and/or of second segment 224 with respect to the light transmission direction of first segment 222 may be implemented.

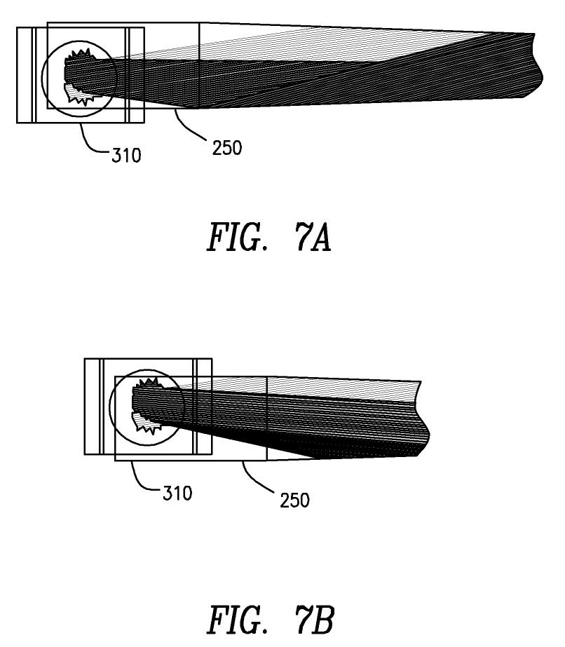

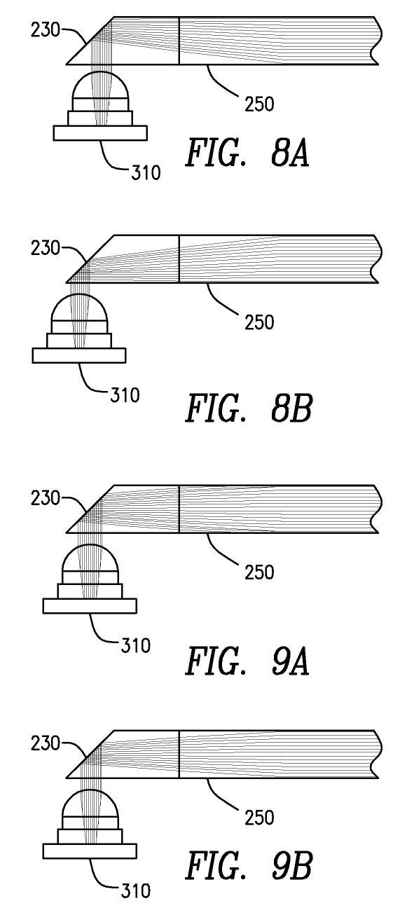

FIGS. 7A and 7B are plan views of fluctuations of light flow patterns as a function of variation in the relative locations of light source 310 and a light path structure along an X axis of an X-Y-Z coordinate system. The X axis is the direction into and out of the page in FIGS. 8A, 8B, 9A, and 9B. The X axis corresponds to the up and down direction in the view of FIGS. 7A and 7B.

FIG. 7 illustrates the effects of mislocating light pipe 250 with respect to light source 310 along the X axis. FIG. 7A shows the effect of mislocating the light pipe 250 by +3 mm along the X axis (upward in the view of FIG. 7A) with respect to a location properly centered with respect to light source 310. FIG. 7B shows the effect of mislocating the light pipe 250 by −3 mm along the X axis (downward in the view of FIG. 7B) with respect to a location properly centered with respect to light source 310.

FIG. 8 illustrates the effects of mislocating light pipe 250 with respect to light source 310 along the Y axis. FIG. 8A shows the effect of mislocating the light pipe 250 by +3 mm along the Y axis (leftward in the view of FIG. 8A) with respect to a location properly centered with respect to light source 310. FIG. 8B shows the effect of mislocating the light pipe 250 by −3 mm along the Y axis (rightward in the view of FIG. 8B) with respect to a location properly centered with respect to light source 310.

FIG. 9 illustrates the effects of mislocating light pipe 250 with respect to light source 310 along the Z axis. FIG. 9A shows the effect of mislocating the light pipe 250 by +4 mm along the Z axis (upward in the view of FIG. 9A) with respect to a reference Z-axis light-pipe location in relation to light source 310. FIG. 9B shows the effect of mislocating the light pipe 250 by −2 mm along the Z axis (downward in the view of FIG. 9B) with respect to a reference Z-axis light-pipe position in relation to light source 310. The illustrations in FIGS. 7-9 generally illustrate that various embodiments of the present invention provide tolerance for imperfect placement of light pipe 250 with respect to light source 310.

As indicated best at FIGS. 2-3, the indicator is preferably installed nearby the latch 250 on such modules and between the locations 195 and 198 of the connection ports used to receive and transmit optical communications signals. The front portion 177 is preferably curvilinear, as best indicated in FIG. 1.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A communication interface module comprising:
a circuit board having an electronic communication interface and an optical communication interface;
a light source disposed on the circuit board, wherein the light source is indicative of a status of at least one operational condition of the module;
a module cover coupled to the circuit board; and
a light path extending from the light source on the circuit board to a portion of the module cover visible to a human operator.

2. The interface module of claim 1 wherein the cover comprises:
a groove extending along the length of the cover, wherein the groove is configured to accommodate a light pipe therein.

3. The interface module of claim 2 wherein the light pipe extends at least substantially through the groove.

4. The interface module of claim 3 wherein an end of the light pipe farthest from the reflector is operable to establish a termination point of the light path.

5. The interface module of claim 1 wherein the light path includes a first segment extending substantially normal to a plane of a top surface of the circuit board, and a second segment extending parallel to the plane of the top surface of the circuit board.

6. The interface module of claim 5 wherein the light path further includes a reflector operable to reflect light from the first segment of the light path to the second segment of the light path.

7. The interface module of claim 6 wherein the reflector includes a reflection surface oriented at about a 45-degree angle with respect to the plane of the top surface of the circuit board.

8. The interface module of claim 2 wherein the light pipe is composed of at least one material selected from the group consisting of: a) polycarbonate; and b) polymethylmethacrylate (PMMA).

9. The interface module of claim 1 wherein activation of the light source is operable to indicate a fault condition.

10. The interface module of claim 1 wherein activation of the light source is operable to indicate a fault condition in an optical circuit.

11. A method comprising:
providing a light source on a circuit board for an optical communication circuit;
assembling a cover to the circuit board to form an interface module;
providing a light path from the light source through at least a portion of the cover to at least one illumination surface of the cover, wherein the illumination surface is visible to a human operator; and
illuminating the light path in response to at least one operating condition of the communication circuit.

12. The method of claim 11 wherein the light path comprises at least one reflector surface for reflecting light received from the light source on the circuit board.

13. The method of claim 11 wherein the cover further comprises:
a groove able to accommodate a light pipe.

14. The method of claim 13 further comprising:
directing light from the reflector along the light pipe.

15. The method of claim 11 wherein the step of illuminating comprises:
illuminating the light path in response to a fault condition in the communication circuit.

16. An optical transceiver comprising an optical receiver, an optical transmitter, and a light pipe for conveying light from an inner, portion of said optical transceiver not viewable by a user to an outside portion viewable by a user, said optical transceiver having a receive port and transmission port, and a latch, said latch being at a location longitudinally on said transceiver, said outside portion being between said receive and transmission ports, and at substantially the same longitudinal location on said transceiver as said latch.

17. The optical transceiver of claim 16 wherein said ports are separated by a curvilinear front wall portion, said curvilinear front wall portion having an indicator thereon.
